(19) United States
(12) Patent Application Publication
(10) Pub. No.: US 2025/0370416 A1
(43) Pub. Date: Dec. 4, 2025

(54) MULTIPLE CONTROLLING AND MONITORING METHOD AND APPARATUS

(71) Applicant: HANWHA AEROSPACE CO., LTD., Changwon-si (KR)

(72) Inventor: Sung Jae JANG, Changwon-si (KR)

(73) Assignee: HANWHA AEROSPACE CO., LTD., Changwon-si (KR)

(21) Appl. No.: 18/972,291

(22) Filed: Dec. 6, 2024

(30) Foreign Application Priority Data
Jun. 4, 2024 (KR) 10-2024-0073139

(51) Int. Cl. G05B 13/02

(52) U.S. Cl. CPC G05B 13/027

(57) ABSTRACT

An apparatus configured to control and monitor a plurality of devices includes: at least one processor and at least one memory storing instructions executable by the at least one processor, where, by executing the instructions, the at least one processor is configured to control: a manager node to manage operations of the plurality of devices, based on a platform identification identifier and an environment identification identifier for the plurality of devices; an artificial intelligence node to: determine an inference value for the platform identification identifier and the environment identification identifier based on a pre-trained artificial intelligence model, and transmit the inference value to the manager node; and a control node to control the plurality of devices based on a control command obtained from the manager node.

### CROSS-REFERENCE TO RELATED APPLICATION

This application is based on and claims priority to Korean Patent Application No. 10-2024-0073139, filed on Jun. 4, 2024, in the Korean Intellectual Property Office, the disclosure of which is incorporated herein in its entirety by reference.

### BACKGROUND

### 1. Field

The disclosure relates to multiple controlling and monitoring methods and apparatuses.

### 2. Description of Related Art

In a robot operating system 1 (ROS1) of the related art, each node is controlled using a master node without a data distribution service (DDS). In this case, since a program is designed based on a master node, management and complexity may increase. Specifically, with a configuration designed based on a master node, there is a limit to the amount of data that can be managed. The ROS1 uses a transmission control protocol robot operating system (TCPROS) communication library. However, a robot operating system 2 (ROS2) is a user data protocol (UDP) communication-based framework. The ROS2 supports Linux, Windows, and macOS on a platform side. The ROS2 is an operating system (OS) that supports real-time compared to the ROS1 and uses a real time publish subscribe (RTPS) protocol of a DDS. In the ROS2, a DDS has been introduced for security. Since the DDS supports an automatic sensing function between nodes, communication between several DDS programs is possible without a ROS master. The ROS2 supports a real time operating system (RTOS) and DDS-extremely resource constrained environments (XRCE).

Issues of the related art are concentrated on the master node of the ROS1, and thus, a lower device may be inefficient in terms of monitoring or management and may have a large load. In the ROS1, a large-scale application programming interface (API) needs to be changed in order to provide functions to a new request such as various robots, real-time control, and OS. The ROS2 provides for multi-platform support (Windows, Linux, and macOS), allows flexible development, and allows each node to operate independently without a master node. However, when nodes operate independently without a master node, the system becomes complex, and it may be difficult to manage and monitor the nodes. In addition to the development of artificial intelligence, a technology is needed that efficiently manages and monitors nodes. As the number of systems and linkages between the systems increases in the defense industry, it is necessary to prepare node management and monitoring technology.

### SUMMARY

Provided is a method of controlling and monitoring a plurality of devices, and a controlling and monitoring apparatus. However, these tasks are examples and the scope of the disclosure is not limited thereto.

Additional aspects will be set forth in part in the description which follows and, in part, will be apparent from the description, or may be learned by practice of the presented embodiments of the disclosure.

According to an aspect of the disclosure, an apparatus configured to control and monitor a plurality of devices may include: at least one processor and at least one memory storing instructions executable by the at least one processor, where, by executing the instructions, the at least one processor may be configured to control: a manager node to manage operations of the plurality of devices, based on a platform identification identifier and an environment identification identifier for the plurality of devices; an artificial intelligence node to: determine an inference value for the platform identification identifier and the environment identification identifier based on a pre-trained artificial intelligence model, and transmit the inference value to the manager node; and a control node to control the plurality of devices based on a control command obtained from the manager node.

The manager node may include a plurality of manager nodes corresponding to functions of the plurality of devices.

The at least one processor may be further configured to control the artificial intelligence node to: train the artificial intelligence model based on feature data representing characteristics of a platform and an environment, and extract and compress the feature data representing characteristics of the platform and the environment based on a preset algorithm for the platform identification identifier and the environment identification identifier.

The at least one processor may be further configured to control the artificial intelligence node to transmit the inference value common to the plurality of manager nodes at a same time.

The plurality of manager nodes may include: a first manager node corresponding to a path following function; a second manager node corresponding to a path planning function; and a third manager node corresponding to an obstacle detection function.

The platform identification identifier may include at least one of: a ground platform identifier, an aerial platform identifier, or a water floating platform identifier.

The environment identification identifier may include at least one of: a road environment, a field environment, or an obstacle environment.

According to an aspect of the disclosure, a method of controlling and monitoring a plurality of devices may include: managing, by a manager node, operations of the plurality of devices based on a platform identification identifier and an environment identification identifier for the plurality of devices; determining, by an artificial intelligence node, inference values for the platform identification identifier and the environment identification identifier based on a pre-trained artificial intelligence model, and transmitting the inference values to the manager node; and controlling, by a control node, the plurality of devices based on a control command obtained from the manager node.

The managing the operations of the plurality of devices may include managing the operations of the plurality of devices based on a plurality of manager nodes corresponding to functions of the plurality of devices.

The transmitting the inference values to the manager node may include: training the artificial intelligence model based on feature data representing characteristics of a platform and an environment, and extracting and compressing, by a preset algorithm, the feature data representing characteristics of the platform and the environment to obtain the platform identification identifier and the environment identification identifier.

The transmitting the inference values to the manager node may include transmitting the inference values common to the plurality of manager nodes at a same time.

According to an aspect of the disclosure, a non-transitory recording medium storing a computer program, which, when executed, may cause at least one processor to execute the method including: managing, by a manager node, operations of the plurality of devices based on a platform identification identifier and an environment identification identifier for the plurality of devices; determining, by an artificial intelligence node, inference values for the platform identification identifier and the environment identification identifier based on a pre-trained artificial intelligence model, and transmitting the inference values to the manager node; and controlling, by a control node, the plurality of devices based on a control command obtained from the manager node.

According to an aspect of the disclosure, an unmanned vehicle may include: a plurality of devices corresponding to a plurality of functions of the unmanned vehicle; at least one processor operatively connected to the plurality of devices; at least one memory storing instructions executable by the at least one processor, where, by executing the instructions, the at least one processor is configured to control: a manager node to manage operations of the plurality of devices, based on a platform identification identifier and an environment identification identifier for the plurality of devices; an artificial intelligence node to determine an inference value for the platform identification identifier and the environment identification identifier based on a pre-trained artificial intelligence model, and transmit the inference value to the manager node; and a control node to control the plurality of devices based on a control command obtained from the manager node.

The manager node may include a plurality of manager nodes corresponding to functions of the plurality of devices.

The plurality of manager nodes may include: a first manager node corresponding to a path following function; a second manager node corresponding to a path planning function; and a third manager node corresponding to an obstacle detection function.

Other aspects, features, and advantages other than those described above will become apparent from the following detailed description, claims, and drawings.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a configuration and operation of a multiple controlling and monitoring apparatus according to an embodiment;

FIG. 2 is a diagram illustrating a configuration and an operation of a processor according to an embodiment; and

FIG. 3 is a flowchart illustrating a multiple controlling and monitoring method according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “or” includes any and all combinations of one or more of the associated listed items. Expressions such as “at least one of,” when preceding a list of elements, modify the entire list of elements and do not modify the individual elements of the list.

The effects and features of the disclosure, and methods of achieving the effects and features, will become apparent with reference to the embodiments described in detail with reference to the drawings. However, the disclosure is not limited to the embodiments disclosed below, but may be implemented in various forms.

Hereinafter, embodiments of the disclosure will be described in detail with reference to the accompanying drawings, and the same or corresponding components will be denoted by the same reference numerals and redundant descriptions thereof will be omitted.

In the disclosure, terms such as first, second, and the like are used for the purpose of distinguishing one component from another component, and should not be construed to limit the corresponding component in other aspects (e.g., importance or order). In addition, singular expressions include plural expressions unless the context clearly means otherwise. In addition, terms such as include, comprise, have, or the like, indicate that the features or components described in the disclosure exist, and do not exclude the possibility of adding one or more other features or components.

In the drawings, for convenience of description, the components may be exaggerated or reduced in size. For example, since the size and thickness of each component shown in the drawings are arbitrarily shown for convenience of explanation, the disclosure is not necessarily limited to those illustrated.

In the following embodiment, when a part of an area, component, part, block, or module is above or on another part, it includes not only the case directly on the other part, but also the case where another area, component, part, block, or module is arranged in the middle. It will be understood that when a region, component, unit, block, module, or the like is connected, the region, component, unit, block, or module may be directly connected to another region, component, region, block, or module or may be indirectly connected to another region, component, region, block, or module, since another area, component, part, block, or module is arranged in the middle.

Hereinafter, various embodiments will be described in detail with reference to the accompanying drawings in order to easily implement the disclosure by one of ordinary skill in the art.

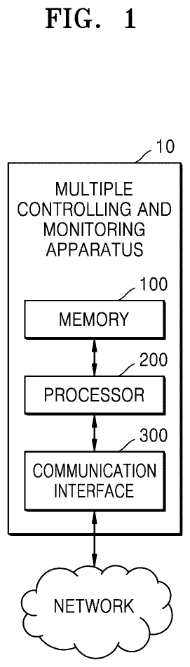

FIG. 1 is a diagram illustrating a configuration and operation of a multiple controlling and monitoring apparatus according to an embodiment.

Referring to FIG. 1, a management apparatus 10 configured to control and monitor a plurality of devices according to an embodiment may include a memory 100, a processor 200, and a communication interface 300. However, the disclosure is not limited thereto, and some components of the management apparatus 10 may be separated into a plurality of devices, or a plurality of components may be merged into one device.

The memory 100 is a computer-readable recording medium and may include at least one memory. For instance, the memory 100 may include a random access memory (RAM), a read only memory (ROM), and a permanent mass storage device such as a disk drive. In addition, program code for controlling the multiple controlling and monitoring apparatus 10 may be temporarily or permanently stored in the memory 100.

The processor 200 may control the overall operations of the management apparatus 10. For example, the processor 200 may be implemented in a form that selectively includes one or more processors, application-specific integrated circuits (ASICs), other chipsets, logic circuits, registers, communication modems, and/or data processing devices known in the art to perform the operations described above. For example, the processor 200 may perform basic arithmetic, logic, and input/output operations, and for example, execute program code stored in the memory 100. The processor 200 may control data to be stored in the memory 100 or load data stored in the memory 100.

The processor 200 may learn a neural network using a program stored in the memory 100. Here, the neural network may be designed to simulate the structure of the human brain on a computer, and may include a plurality of network nodes having weights that simulate the neurons of the human neural network. A plurality of network nodes may transmit and receive data according to a connection relationship so that neurons simulate synaptic activity of neurons that transmit and receive signals through synapses. Here, the neural network may include a deep learning model developed from the neural network model. In a deep learning model, multiple network nodes may be located in different layers and exchange data based on convolutional connection relationships.

For example, examples of neural network models may include various deep learning techniques, such as deep neural networks (DNN), convolutional deep neural networks (CNN), recurrent neural networks (RNN), restricted Boltzmann machine (RBM), deep belief networks (DBN), deep Q-networks, and the like, and may be applied to fields, such as computational vision, voice recognition, natural language processing, voice/signal processing, and the like.

The processor performing the function as described above may be one or more of a general-purpose processor (e.g., a central processing unit (CPU)), or may be an AI-specific processor for artificial intelligence learning (e.g., a graphical processing unit (GPU)).

The communication interface 300 may provide a function for communicating with an external device through a network. For example, a request generated by the processor of the controlling and monitoring apparatus 10 according to a program code stored in a recording device such as a memory may be transmitted to an external server through the network under the control by the communication interface 300. Conversely, control signals, commands, content, files, etc. provided under the control by the processor of an external server may be received by the controlling and monitoring apparatus 10 through the communication interface 300 via the network. For example, the control signals or commands of the external server received through the communication interface 300 may be transmitted to the processor 200 or the memory 100.

The communication scheme is not limited, and short-range wireless communications between devices may be included, as well as a communication scheme utilizing a communication network (e.g., a mobile communication network, a wired Internet, a wireless Internet, a broadcast network) that a network may include. For example, the network may include one or more networks among networks, such as a personal area network (PAN), a local area network (LAN), a campus area network (CAN), a metropolitan area network (MAN), a wide area network (WAN), a broadband network (BBN), and the Internet. In addition, the network may include any one or more of network topologies including a bus network, a star network, a ring network, a mesh network, a star-bus network, a tree, or a hierarchical network, but is not limited thereto.

In addition, the controlling and monitoring apparatus 10 according to an embodiment may include an input/output interface. The input/output interface may be implemented as an interface for an input/output device. The input/output interface may display state information of current equipment. For example, an input device may include a device such as a keyboard or mouse, and an output device may include a device such as a display for displaying a communication session of an application. As another example, the input/output interface may include an interface with a device in which functions for input and output are integrated into one, such as a touch screen.

Further, in some embodiments, the controlling and monitoring apparatus 10 may include more components than the number of the components of FIG. 1. For example, the controlling and monitoring apparatus 10 may be implemented to include at least some of the input/output devices described above, or may further include other components such as a battery and charging device for supplying power to internal components, various sensors, a database, etc.

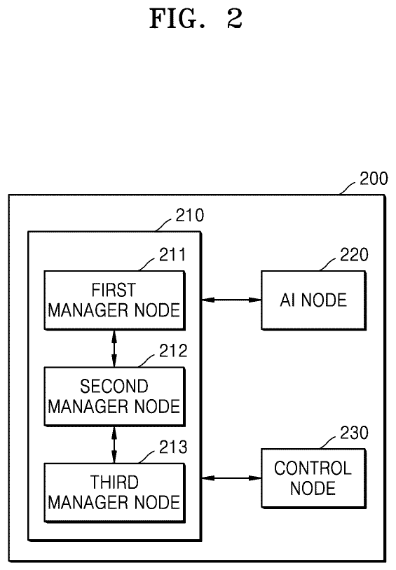

FIG. 2 is a diagram illustrating a configuration and an operation of the processor 200 according to an embodiment.

Referring to FIG. 2, the processor 200 according to an embodiment may include a manager node 210, an AI node 220 (e.g., an artificial intelligence node), and a control node 230. For example, the manager node 210 may include a plurality of manager nodes respectively corresponding a function of a device among a plurality of devices. Here, the device may represent a device included in a manned or unmanned driving vehicle, a drone, or the like.

For example, as illustrated in FIG. 2, the manager node 210 may include a first manager node 211, a second manager node 212, and a third manager node 213. Here, the first manager node 211 may be a manager node that manages a path following function. In addition, the second manager node 212 may be a manager node that manages a path planning function. In addition, the third manager node 213 may be a manager node that manages an obstacle detection function. For example, the manager node 210 may further include a manager node that manages a sensor signal processing function, a driving available area analysis function, a collision avoidance function, and the like.

The manager node 210 may monitor a plurality of devices based on a platform identification identifier and an environment identification identifier for the plurality of devices and manage the operations of the plurality of devices. For example, the platform identification identifier may indicate an identifier that discriminates a platform on which the device operates. For example, the platform identification identifier may include identifiers (e.g., numbers such as 0, 1, 2, etc.) representing a ground platform, an aerial platform, or a water floating platform. In addition, the environment identification identifier may indicate an identifier that discriminates an environment in which the device operates. For example, the environmental identification identifier may include an identifier (e.g., a character such as a, b, c, etc.) representing a road environment, a field environment, an obstacle environment, and the like.

The artificial intelligence node 220 may determine an inference value for the platform identification identifier and the environment identification identifier using a pre-trained artificial intelligence model, and transmit the inference value to the manager node.

For example, the platform identification identifier and the environment identification identifier input to the manager node 210 may be set values input by a user. However, in preparation for various situations, such as when communication with the user is lost due to various environments or when the user's judgment is not appropriate, the artificial intelligence node 220 may derive an inference value for the platform identification identifier and the environment identification identifier and transmit the inference value to the manager node. In this case, the manager node 210 may change a setting value for the platform identification identifier and the environment identification identifier based on the inference value received from the artificial intelligence node 220.

The manager node 210 may determine control commands for a plurality of devices based on an inference value or a setting value for the platform identification identifier and the environment identification identifier. Alternatively, the manager node 21 may receive control commands for the plurality of devices from the artificial intelligence node 220. In this case, the artificial intelligence node 220 may determine control commands for the plurality of devices based on the inference value for the platform identification identifier and the environment identification identifier.

The control node 230 may control the plurality of devices based on the control commands obtained from the manager node 210.

The artificial intelligence node 220 according to an embodiment may learn the artificial intelligence model based on feature data representing the characteristics of the platform and environment, which are extracted and compressed by a preset algorithm for the platform identification identifier and the environment identification identifier. For example, the feature data may be data used for training an artificial intelligence model used by the artificial intelligence node 220. For example, feature data may represent characteristic data representing characteristics of the platform or environment among all data about the platform or environment acquired by the device. For example, the artificial intelligence node 220 may be trained based on feature data.

The artificial intelligence node 220 according to an embodiment may transmit an inference value common to a plurality of manager nodes at a same time. For example, the artificial intelligence node 220 may transmit a message common to a plurality of manager nodes by an artificial intelligence node 220 at a same time. In addition, the artificial intelligence node 220 may integrate and manage a plurality of manager nodes.

At least one of the nodes represented by a block as illustrated in FIG. 2 may be embodied as various numbers of hardware, software and/or firmware structures that execute respective functions described above, according to an exemplary embodiment. For example, at least one of these nodes may use a direct circuit structure, such as a memory, processing, logic, a look-up table, etc. that may execute the respective functions through controls of one or more microprocessors or other control apparatuses. Also, at least one of these nodes may be specifically embodied by a module, a program, or a part of code, which contains one or more executable instructions for performing specified logic functions, and executed by one or more microprocessors or other control apparatuses. Also, at least one of these nodes may further include a processor such as a central processing unit (CPU) that performs the respective functions, a microprocessor, or the like. Functional aspects of the above exemplary embodiments may be implemented in algorithms that execute on one or more processors. Furthermore, the nodes represented by a block or processing steps may employ any number of related art techniques for electronics configuration, signal processing and/or control, data processing and the like.

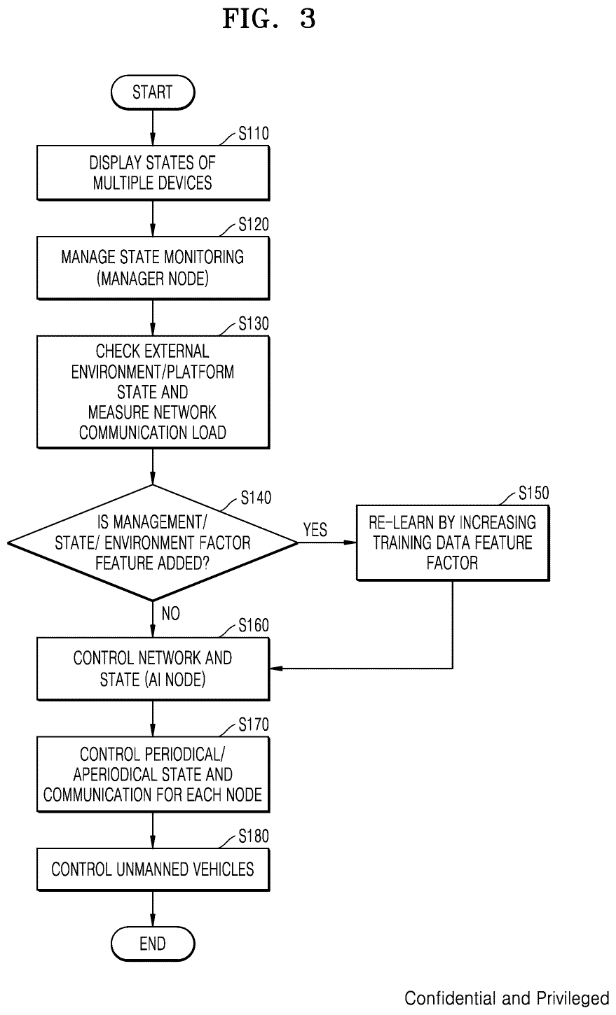

FIG. 3 is a flowchart illustrating a multiple controlling and monitoring method according to an embodiment.

The method for controlling and monitoring a plurality of devices according to an embodiment may be performed by the controlling and monitoring apparatus illustrated in FIGS. 1 and 2.

The controlling and monitoring method according to an embodiment may be performed for controlling and monitoring a plurality of devices provided in an unmanned vehicle among a process of controlling and monitoring the driving of a plurality of unmanned vehicles.

Referring to FIG. 3, in operation S110, a plurality of device states provided in an unmanned vehicle may be acquired and displayed on a display device of the unmanned vehicle or a display device of a central control device.

In operation S120, the manager node may monitor and manage states of the plurality of devices. For example, the manager node may be provided in the unmanned vehicle. In addition, the plurality of devices may represent a plurality of devices provided in an unmanned vehicle, such as a steering device of an unmanned vehicle and various sensors.

In operation S130, the manager node may check the external environment and platform state for a plurality of devices, and may check the communication state. For example, the manager node may check a communication state by measuring a network communication load.

In operations S140 and S150, when new feature data is added to an external environment and platform, the artificial intelligence node may train the artificial intelligence model using the feature data.

In operation S160, the artificial intelligence node may check the network state with the manager node and control the network state. In addition, the artificial intelligence node may control, integrate and manage a plurality of manager nodes.

In operation S170, the artificial intelligence node may check a periodic or aperiodic network state for each manager node and control communication for each manager node with respect to the plurality of manager nodes.

In operation S180, the control node may control the plurality of devices based on the control command acquired from the manager node.

The technology of the disclosure relates to a node technology for managing a control processor in a vehicle. The disclosure may be used for state management and cluster control of multiple devices in the field of defense. In addition to the defense field, a commercial field also uses a robot operating system (ROS), which is a corresponding robot middleware or software framework. Unmanned vehicles have been developed as ROS1 in the existing defense field, but the technology has been currently changed into ROS2 by adopting the fast data distribution service (DDS) scheme without a master node. In the ROS1, a large-scale application programming interface (API) needs to be changed in order to provide functions to a new request such as various robots, real-time control, and OS. With the transition from ROS1 to ROS2, the system of individual nodes without master nodes will be developed and expanded. The transition to the ROS2 system may increase interest in node monitoring and management technologies. There is a need for the technology of the disclosure in connection with system interworking between a system and another system in the field of defense.

The issues of the related art are concentrated on the master node of ROS1, which is suitable for a single product configuration, but the complexity of state monitoring and management increases when linking the system with the device. In order to solve node management and monitoring issues without a master node in the ROS2, the disclosure provides a manager node and an artificial intelligence node. The manager node is designed as a message interface node including a platform identification identifier (e.g., an ID) and an environment identification identifier (e.g., an ID) in order to cope with a platform type and an environment setting change. The artificial intelligence model may respond to complex setting changes of manager nodes on the basis of data. The artificial intelligence node may be configured to put a value of the inference result of the artificial intelligence model into a message data field.

The related art in the defense field is one that uses a TCPROS communication library that has a ROS1 master node and does not use a DDS. A way to circumvent the related techniques is to use a DDSI-RTPS, which has no master node which is a feature of the ROS2 and is a publisher and subscribe protocol of the DDS. According to the disclosure, an artificial intelligence (AI) node, a manager node, and a control node may be included in an information processing module or a single board computer (SBC) in the corresponding ROS2 technology base.

The management apparatus according to some embodiments may reduce the complexity of ROS2. Through the distributed system of ROS2 and the real-time support function, the management apparatus may reduce the system load due to the reduced computational amount and reduce the complexity. In some embodiments, the management apparatus may be capable of quickly adapting to the dynamic environmental changes of the vehicle may be managed as a manager node and operate in a hybrid form of centralized control and distributed control, so that the system maintains flexible and reliable performance and reduce the complexity. In order to achieve this hybrid form, some embodiments of the management apparatus may include the AI node, and may automatically manage the manager nodes to reduce the computational amount and the system load.

According to some embodiments, the management apparatus may manage functions by integrating the distributed system and real-time support functions in relation to the complexity of the ROS2.

In some embodiments, the management apparatus may be responsible for the integrated management of all sensors and control modules in the system. Through this, it may effectively connect sensor data and control commands by utilizing ROS2's DDS and may optimize communication between nodes on the network.

When a new sensor or module is added to the system, the manager node may automatically detect it and dynamically integrate it to increase the flexibility of the system. For example, the data flow of updated sensors can be adjusted, or the priority of specific nodes in an emergency can be increased to process important data immediately.

According to some embodiments, the manager node may centrally control the QoS settings of each node to manage the reliability and priority of data. This may adjust the amount of computation to reduce complexity. During autonomous driving, important sensor data (e.g. collision warning, road condition changes) can be delivered with high reliability, and less important data (e.g. long-term driving plan updates) can be adjusted to be ignored when delayed. This may ensure both system stability and real-time performance (complexity reduction).

In some examples, in a real-time environment, the manager node may adjust the real-time scheduling of each node to ensure that control commands (e.g. speed control, lane change, etc.) are reflected within a certain time. In this case, predictable performance may be maintained by using methods such as pre-memory allocation to meet real-time requirements. For example, when a vehicle passes through a complex intersection or is in an emergency situation, the manager node may be capable of dynamically adjusting the priority of commands in real time to maximize responsiveness.

In some examples, using the manager node of ROS2 may enable advanced management and control of autonomous driving functions, and can contribute to improving the safety and functional efficiency of the vehicle and while reducing complexity. According to some embodiments, using the AI node to manage centralized or distributed control of multiple manager nodes may reduce system load and complexity in the ROS2 system.

Therefore, when a complex system needs to be flexibly distributed and output real-time performance, the above advantages of ROS2 may be realized.

However, the above-described embodiments are merely specific examples to describe technical content and effects according to embodiments of the disclosure, and help the understanding of the embodiments of the disclosure, not intended to limit the scope of the embodiments of the disclosure.

The apparatus and/or system described above may be implemented as a hardware component, a software component and/or a combination of a hardware component and a software component. The apparatus and components described in the embodiments may be implemented using one or more general purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to an instruction. The processing device may perform an operating system (OS) and one or more software applications executed on the operating system. In addition, the processing device may access, store, manipulate, process and generate data in response to the execution of the software. For convenience of understanding, although one processing device has been described as being used, one of ordinary skill in the art may recognize that the processing device may include a plurality of processing elements and/or a plurality of types of processing elements. For example, the processing device may include a plurality of processors or one processor and one controller. In addition, other processing configurations, such as parallel processors, are also possible.

The software may include a computer program, code, an instruction, or some combination thereof, to configure the processing device to operate as desired or independently or collectively instruct the processing device. Software and/or data may be permanently or temporarily embodied in any type of machine, component, physical device, virtual equipment, computer storage medium or device, or transmitted signal wave to be interpreted by the processing device or to provide commands or data to the processing device. The software may be distributed over a networked computer system and stored or executed in a distributed manner. Software and data may be stored in one or more computer-readable recording media.

The method according to an embodiment may be implemented in the form of program instructions that may be executed through various computer means and recorded on a computer-readable medium. The computer-readable medium may include program instructions, data files, data structures, and the like, alone or in combination. The program instructions recorded on the media may be specially designed and configured for the embodiments, or may be known and available to those having ordinary skill in the computer software arts. Examples of computer-readable recording media include magnetic media such as hard disks, floppy disks and magnetic tapes, optical media such as CD-ROMs and DVDs, magneto-optical media such as floptical disks, and hardware devices specifically configured to store and execute program instructions such as ROMs, RAMs, flash memories, etc. Examples of program instructions include machine language codes such as those created by a compiler, as well as advanced language codes that may be executed by a computer using an interpreter or the like. The hardware devices described above may be configured to operate as one or more software modules to perform the operations of the embodiments, and vice versa.

According to an embodiment as described above, controlling and monitoring of a plurality of devices may be efficiently managed. Of course, the scope of the disclosure is not limited by these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An apparatus configured to control and monitor a plurality of devices, the apparatus comprising:
at least one processor and at least one memory storing instructions executable by the at least one processor, wherein, by executing the instructions, the at least one processor is configured to control:
a manager node to manage operations of the plurality of devices, based on a platform identification identifier and an environment identification identifier for the plurality of devices;
an artificial intelligence node to:
determine an inference value for the platform identification identifier and the environment identification identifier based on a pre-trained artificial intelligence model, and
transmit the inference value to the manager node; and
a control node to control the plurality of devices based on a control command obtained from the manager node.

2. The apparatus of claim 1, wherein the manager node comprises a plurality of manager nodes corresponding to functions of the plurality of devices.

3. The apparatus of claim 2, wherein the at least one processor is further configured to control the artificial intelligence node to:
train the artificial intelligence model based on feature data representing characteristics of a platform and an environment, and
extract and compress the feature data representing characteristics of the platform and the environment based on a preset algorithm for the platform identification identifier and the environment identification identifier.

4. The apparatus of claim 2, wherein the at least one processor is further configured to control the artificial intelligence node to transmit an inference value common to the plurality of manager nodes at a same time.

5. The apparatus of claim 3, wherein the plurality of manager nodes comprise:
a first manager node corresponding to a path following function;
a second manager node corresponding to a path planning function; and
a third manager node corresponding to an obstacle detection function.

6. The apparatus of claim 1, wherein the platform identification identifier comprises at least one of: a ground platform identifier, an aerial platform identifier, or a water floating platform identifier.

7. The apparatus of claim 1, wherein the environment identification identifier comprises at least one of: a road environment, a field environment, or an obstacle environment.

8. The apparatus of claim 3, wherein the at least one processor is further configured to control the artificial intelligence node to control a communication state for each of the plurality of manager nodes.

9. A method of controlling and monitoring a plurality of devices, the method comprising:
managing, by a manager node, operations of the plurality of devices based on a platform identification identifier and an environment identification identifier for the plurality of devices;
determining, by an artificial intelligence node, inference values for the platform identification identifier and the environment identification identifier based on a pre-trained artificial intelligence model, and transmitting the inference values to the manager node; and
controlling, by a control node, the plurality of devices based on a control command obtained from the manager node.

10. The method of claim 9, wherein the managing the operations of the plurality of devices comprises managing the operations of the plurality of devices based on a plurality of manager nodes corresponding to functions of the plurality of devices.

11. The method of claim 10, wherein the transmitting the inference values to the manager node comprises:
training the artificial intelligence model based on feature data representing characteristics of a platform and an environment, and
extracting and compressing, by a preset algorithm, the feature data representing characteristics of the platform and the environment for the platform identification identifier and the environment identification identifier.

12. The method of claim 10, wherein the transmitting the inference values to the manager node comprises transmitting an inference value common to the plurality of manager nodes at a same time.

13. A non-transitory recording medium storing a computer program, which, when executed, causes at least one processor to execute the method of claim 9.

14. An unmanned vehicle comprising:
a plurality of devices corresponding to a plurality of functions of the unmanned vehicle;
at least one processor operatively connected to the plurality of devices;
at least one memory storing instructions executable by the at least one processor,
wherein, by executing the instructions, the at least one processor is configured to control:
a manager node to manage operations of the plurality of devices, based on a platform identification identifier and an environment identification identifier for the plurality of devices;
an artificial intelligence node to determine an inference value for the platform identification identifier and the environment identification identifier based on a pre-trained artificial intelligence model, and transmit the inference value to the manager node; and
a control node to control the plurality of devices based on a control command obtained from the manager node.

15. The unmanned vehicle of claim 13, wherein the manager node comprises a plurality of manager nodes corresponding to functions of the plurality of devices.

16. The unmanned vehicle of claim 14, wherein the plurality of manager nodes comprises:
a first manager node corresponding to a path following function;
a second manager node corresponding to a path planning function; and
a third manager node corresponding to an obstacle detection function.

17. The unmanned vehicle of claim 14, wherein the platform identification identifier comprises at least one of: a ground platform identifier, an aerial platform identifier, or a water floating platform identifier.

18. The unmanned vehicle of claim 14, wherein the environment identification identifier comprises at least one of: a road environment, a field environment, or an obstacle environment.

19. The unmanned vehicle of claim 15, wherein the at least one processor is further configured to control the artificial intelligence node to control a communication state for each of the plurality of manager nodes.

20. The unmanned vehicle of claim 14, wherein the at least one processor is further configured to control the artificial intelligence node to:
train the artificial intelligence model only on new feature data representing characteristics of a platform and an environment.
